(19) United States
(12) Patent Application Publication
(10) Pub. No.: US 2021/0133521 A1
(43) Pub. Date: May 6, 2021

(54) MAXIMIZING A NUMBER OF COLORANTS USED

(71) Applicant: Hewlett-Packard Development Company, L.P., Spring, TX (US)

(72) Inventors: Karsten N. Wilson, Corvallis, OR (US); Frank Evan Perdicaro, Corvallis, OR (US)

(73) Assignee: Hewlett-Packard Development Company, L.P., Spring, TX (US)

(21) Appl. No.: 16/499,960

(22) PCT Filed: Apr. 7, 2017
(86) PCT No.: PCT/US2017/026534

§ 371 Date: Oct. 1, 2019

(51) Int. Cl. G06K 15/02; B41J 2/21; G06K 15/10

(52) U.S. Cl. CPC G06K 15/1836; B41J 2/21; G06K 15/1878; G06K 15/1828; G06K 15/102

(57) ABSTRACT

In an example, an apparatus is described that includes a plurality of fluid ejection devices, a database, and a raster image processor. The plurality of fluid ejection devices eject a plurality of fluids containing a plurality of different colorants. The database stores an entry for a spot color. The entry defines a first subset of the plurality of fluids that combines to emulate the spot color and a second subset of the plurality of fluids that combines to emulate the spot color. The second subset maximizes a number of the plurality of different colorants used. The raster image processor converts a page description of an image including the spot color into rasterized image data using the second subset of the plurality of fluids.

### BACKGROUND

Digital printing technologies rely on the adhesion of fluid particles (e.g., printing fluid particles) to a substrate (e.g., paper, plastic, or other materials) to produce a printed image, such as a recreation of a digital image. The location of the fluid particles on the substrate is electrically controlled to produce a desired image. The fluid particles may be dispensed in the standard subtractive fluid colors (e.g., cyan, magenta, yellow, and black). Additional fluid particles may be dispensed in spot colors, i.e., premixed colors other than the standard subtractive fluid colors. For instance, spot colors are often used in printing product packaging, where very specific colors may server as source identifiers.

### BRIEF DESCRIPTION OF THE DRAWINGS

FIG. 1 is a block diagram of an example system of the present disclosure;

FIG. 2 illustrates a flowchart of an example method for maximizing a number of colorants used to emulate a spot color;

FIG. 3 illustrates a flowchart of an example method for formulating a metameric alternative colorimetric definition of a known spot color; and

FIG. 4 depicts a high-level block diagram of an example computer that can be transformed into a machine capable of performing the functions described herein.

### DETAILED DESCRIPTION

The present disclosure broadly describes an apparatus, method, and non-transitory computer-readable medium for maximizing a number of colorants used to emulate a spot color. As discussed above, spot colors are premixed colors other than the standard subtractive colors used in digital printing. For instance, spot colors are often used in printing product packaging, where very specific colors may server as source identifiers (such colors may also be referred to as “brand colors”). As such, color mismatches and other imperfections may be undesirable when printing spot colors.

When printing solid fills of any color, however, imperfections such as banding may occur, especially if the area of solid fill is relatively large (e.g., more than a few inches in any direction). The cause of the banding may be related to the geometry of the equipment (e.g., the inherent limitations of the geometries of the fluid ejection devices and/or halftoning algorithms), thermal drift of the equipment and/or thermal loading of the fluid ejection dies, variations in the substrate, or other factors.

Examples of the present disclosure emulate spot colors by programming the raster image processor of a fluid ejection system (e.g., printing device) that uses colorants (e.g., suspended in fluid) in addition to the standard subtractive colorants (e.g., cyan, magenta, yellow, and black). In particular, the raster image processor is programmed to maximize a number of the different colorants that are used to emulate a spot color. In one example, more than two of the available fluid colors (containing at least two different colorants) are combined to emulate the spot color. A spot color database is accessible by the raster image processor and contains entries that identify, for a given spot color, a metameric alternative colorimetric definition (i.e., an alternate combination of the available fluid colors that can produce a color that appears the same to the human eye as a default calorimetric definition for the spot color). The metameric alternative colorimetric definition maximizes the number of different colorants that are combined to produce the spot color by maximizing the number of the different available fluid colors (e.g., combines more than two of the different available fluid colors). By maximizing the number of the different colorants used to produce the spot color, the appearance of banding (as far as can be detected by the human eye) can be greatly reduced in the output of the printing device

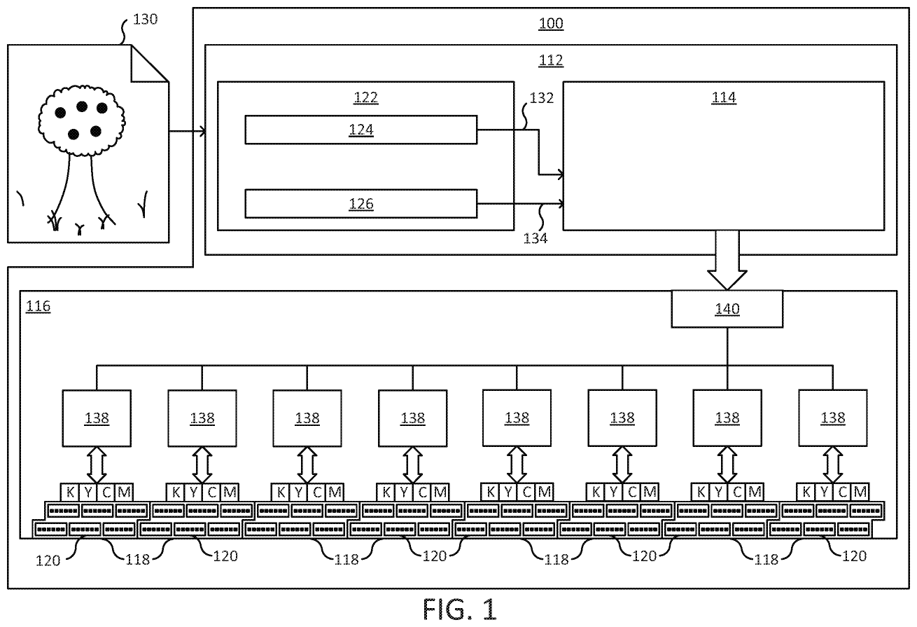

FIG. 1 illustrates an example system 100 of the present disclosure. In one example, the system 100 is a fluid ejection system, such as an inkjet printing device or a packaging web press. The system 100 generally includes an image processing system 112 and a print engine 116, The image processing system 112 and print engine 116 work together to convert original image data 130 (e.g., a digital image) into a printed image on a substrate.

In one example, the image processing system 112 further comprises a raster image processor (RIP) 122 and a fluid ejection controller 114, The RIP 122 converts the page description language (PDL) describing the original image data 130 to rasterized (e.g., inkjet) image data 132. To this end, the RIP 122 includes a color conversion module 124 and a spot color database 126. The color conversion module 124 performs color conversion on the original image data 130 and may additionally map the colors to generate continuous tone (or “contone”) rasterized image data 132. The color conversion module 124 may use one or more page description languages to process the original image data 130.

The spot color database 126 stores mixtures for producing spot colors, using any of the colorants or fluid colors available to the system 100. The entries in the spot color database may comprise, for each known spot color, a name or other unique identifier that helps the RIP 122 to identify the correct spot color. Each entry may additionally include one or more colorimetric definitions (e.g., formulations of available colorants or fluid colors, including the names of the colorants or fluid colors and the quantities in which they are mixed) that may be used to produce the associated spot color. In one example, each spot color has at least a first (e.g., default) colorimetric definition. In one example, this default colorimetric definition may seek to minimize the number of different colorants that are used to produce the spot color.

At least some of the spot colors for which entries exist in the spot color database 126 may also have a second (e.g., metameric alternative) color definition. A metamer is an alternate description of a color that appears the same to the human eye as a default description of the color. For example, the color black can be produced by using black colorant without any other colorants (e.g., the default colorimetric definition), or by mixing cyan, magenta, and yellow colorants in appropriate quantities (e.g., the metameric alternative colorimetric definition). Similarly, the color green can be produced using green colorant without any other colorants, or using a mixture of cyan and yellow colorants. Thus, the metameric alternative colorimetric definition of a spot color, within the context of the present disclosure, is a formulation of the available fluid colors (or colorants) that produces a spot color that is, to the human eye, indistinguishable from the same spot color when it is produced by a default formulation of fluid colors (or colorants), In one example, the metameric alternative colorimetric definition of a spot color that is stored in the spot color database 126 may seek to maximize the number of different colorants that are used to produce the associated spot color.

Either or both of the color conversion module 124 and the spot color database 126 may be implemented as a distinct programming element or as part of an integrated program or programming element to perform specified functions. Furthermore, either or both of the color conversion module 124 and the spot color database 126 may include a processor and/or other electronic circuitry and components to execute the programming (i.e., executable instructions) to perform the specified functions. In some examples, modules, such as modules 124 and 126 of FIG. 1, may comprise a combination of hardware and programming to implement the functionalities of the modules.

The fluid ejection controller 114 maps the contone rasterized image data 132 and the selected spot color formulation 134 from the spot color database 126 to drops of printing fluid (e.g., colorant suspended in a liquid, such as printing fluid, toner, detailing agent, or the like) to be dispensed by the fluid ejection devices (e.g., print heads) 120. This information may be used to drive the fluid ejection devices 120 to produce a printed image. Although the fluid ejection controller 114 is illustrated as an internal component of the system 100, some fluid ejection controller functions may be performed outside of the system 100. Thus, the system illustrated in FIG. 1 shows one example configuration that may be used to implement the functionality of the color conversion module 124, the spot color database 126, and the fluid ejection controller 114.

In one example, the print engine 116 is implemented as a modular print bar that includes a plurality of fluid ejection modules 118, each of which is controlled by a respective fluid ejection module controller 138, Each fluid ejection module 118, in turn, includes a plurality of fluid ejection devices 120. The fluid ejection devices 120 may be of the type used in high-speed commercial inkjet printing presses and may comprise a plurality of fluid ejection dies (e.g., pens) that individually eject fluid of different colors. In one example, the fluid ejection controller 114 passes instructions to the print engine 116 via a print bar interface 140.

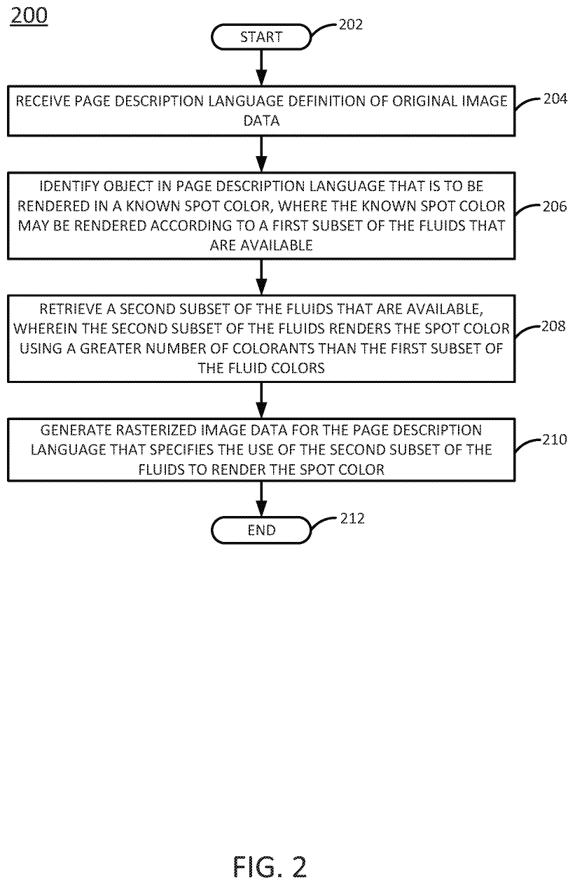

FIG. 2 illustrates a flowchart of an example method 200 for maximizing a number of colorants used to produce a spot color. The method 200 may be performed, for example, by the RIP 122 of the system 100 illustrated in FIG. 1. As such, reference is made in the discussion of FIG. 2 to various components of the system 100 to facilitate understanding. However, the method 200 is not limited to implementation with the system illustrated in FIG. 1.

The method 200 begins in block 202. In block 204, the RIP 122 receives a page description language (PDL) definition describing the original image data 130 to be reproduced.

In block 206, the RIP 122 identifies an object in the PDL that is to be rendered in a known spot color. The known spot color may be rendered according to a first (e.g., default) colorimetric definition (i.e., a combination or subset of the fluid colors or colorants that are available to the system 100). Thus, the first calorimetric definition emulates the known spot color using a first subset of the fluid colors (or colorants) available to the system. As discussed above, in one example, this first colorimetric definition may seek to minimize the number of different colorants that are included in that first subset. For instance, the first subset may contain n different colorants or fluid colors.

In block 208, the RIP 122 retrieves a second (e.g., metameric alternative) colorimetric definition for the known spot color from the spot color database 126. The second colorimetric definition emulates the known spot color using a second subset of the fluid colors or colorants available to the system. As discussed above, in one example, this second colorimetric definition may seek to maximize the number of different fluid colors (or colorants) that are included in that second subset. For instance, if the first subset contained n different colorants or fluid colors, the second subset may contain at least n+1 different colorants or fluid colors. In one example, the second metameric colorimetric definition seeks to utilize colorants from the most-closely-spaced sets of fluid ejection devices in order to mitigate any degradation to the overall alignment of the system that may result from the use of an increased number of colorants.

In block 210, the RIP 122 (e.g., via the color conversion module 124) generates rasterized image data for the PDL that specifies the use of the second colorimetric definition for the known spot color for rendering the object identified in block 206 in the output image.

The method 200 ends in block 212. The rasterized image data produced by the method 200 may be converted to contone rasterized image data as discussed above, or may be sent directly to the fluid ejection controller 114.

By maximizing the number of colorants or fluid colors that are used to emulate a known spot color (and, more specifically, by maximizing the number of fluid ejection dies or pens used to emulate the known spot color), the appearance of banding and other imperfections in solid fill areas of the system output can be minimized. This isn't necessarily to say that the imperfections will not exist; however, the imperfections will be less visible to the human eye. In general, it has been shown that the appearance of the imperfections improves (e.g., lessens) with an increase in the number of colorants and/or fluid ejection devices installed on the system. In other words, the greater the number of colorants that are available/used, the better the results. For instance, a packaging press having a seven-color print bar will be able to generate a greater number of metamers for a given spot color than a press having a four-color print bar.

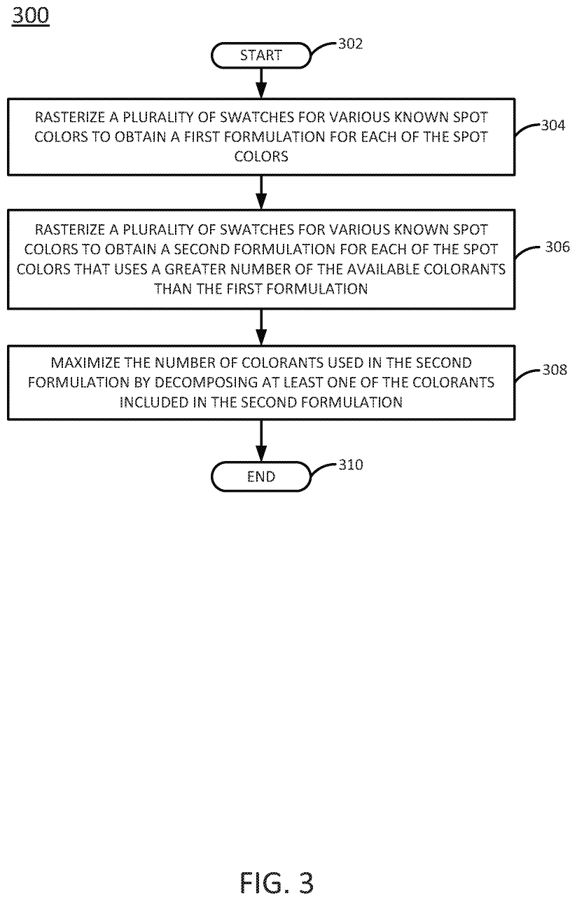

FIG. 3 illustrates a flowchart of an example method 300 for formulating a metameric alternative colorimetric definition of a known spot color. In some examples, the metameric alternative colorimetric definition formulated by the method 300 is a definition that seeks to maximize the number of the available colorants that is used to emulate the spot color. The method 300 may be performed, for example, by the RIP 126 of FIG. 1, possibly in conjunction with an additional processor, to populate the spot color database 126 of FIG. 1 with entries for various spot colors. As such, reference is made in the discussion of FIG. 3 to various components of the system 100 to facilitate understanding. However, the method 300 is not limited to implementation with the system illustrated in FIG. 1.

The method 300 begins in block 302. In block 304, a plurality of color swatches for various known spot colors is rasterized for a first time by the RIP 122 to obtain a first or default formulation for each of the spot colors. In one example, each default formulation comprises a CMYK (cyan, magenta, yellow, black) definition for a respective spot color. The CMYK definition defines the quantities of cyan, magenta, yellow, and black colorants (or fluids) to be mixed to obtain the spot color.

In block 306, a plurality of color swatches for various known spot colors is rasterized for a second time by the RIP 122 to obtain a second or metamer formulation for each of the spot colors. In one example, the metamer formulation comprises a definition for a respective spot color that uses colorants (or fluid colors) in addition to cyan, magenta, yellow, and black, Thus, the metamer formulation uses a greater number of the available colorants than the default formulation.

In block 308, the RIP 122 maximizes the number of colorants used in the metamer definition. That is, the RIP seeks to identify the formulation for the spot color that uses the greatest number of the available colorants. In one example, the number of colorants is maximized by applying an inverse under color remove (UCR) function to the black colorant or fluid and any other colorant or fluid colors in the metamer definition that are not cyan, magenta, or yellow. For instance, a formulation for the black colorant could be decomposed into a mixture of less black colorant, plus cyan, magenta, and yellow colorants, thereby producing the same color with four times the number of colorants. Similarly, green colorant could be decomposed into a mixture of less green colorant, plus cyan and yellow colorants. Similar decompositions could also be created for orange and violet colorants. Thus, block 308 may decompose at least one of the colorants or fluid colors used in the metamer definition into at least two colorants or fluid colors.

In one example, maximization of the number of colorants in block 308 may be subject to an error analysis function that balances the value of reducing banding in the output against a desired level of color fidelity in the metamer formulation. For instance, a known spot color that has a poor or no known alternative colorimetric definition can be flagged and classified by the area of the output that the known spot color occupies. If the area is relatively physically large, has known banding-prone color, and/or does not have a good metamer formulation, then a user may be informed of potential imperfections in the output.

The method 300 ends in block 310.

It should be noted that although not explicitly specified, some of the blocks, functions, or operations of the methods 200 and 300 described above may include storing, displaying and/or outputting for a particular application. In other words, any data, records, fields, and/or intermediate results discussed in the methods can be stored, displayed, and/or outputted to another device depending on the particular application. Furthermore, blocks, functions, or operations in FIGS. 2-3 that recite a determining operation, or involve a decision, do not necessarily imply that both branches of the determining operation are practiced.

In one example, the RIP 122 may be programmed to utilize the second or metameric alternate colorimetric definition for each known spot color as a default. For instance, the default spot color emulation description used by the RIP could be set to a four-color or six-color definition that is installed on the system, where that definition is specifically created to maximize the number of colorants that is used to produce each emulated spot color.

In another example, the International Color Consortium (ICC) Device Link profile used in the color conversion module 124 of the RIP 122 may be modified to use a maximum number of colorants or fluid colors in the production of spot colors. Device Links are typically expressed as generalized Lab color space (i.e., L*a*b*)-to-CMYK or L*a*b*-to-six-color definition without specific spot color emulation. However, by modifying portions of the transform used for the L*a*b*-to-CMYK or L*a*b*-to-six-color conversion, specific spot colors can be targeted for extended six-color processing, wherein the extended processing is designed to maximize the number of colorants or fluid colors used to emulate the specific spot colors.

In another example still, the spot colors can be detected in the output of the RIP 122. Detection of the spot colors in the output of the RIP 122 is relatively easy, since spot colors tend to have well-known, consistent behavior. Thus, given all raster separations (e.g., color conversions, as determined by the color conversion module 124) for an input image, plus an identifier generated by processing a plurality of spot color swatches (e.g., as in block 304 of the method 300), rasterized spot colors can be detected and altered to maximize the number of colorants or fluid colors used to produce the rasterized spot colors. For instance, each input raster (e.g., first version of the rasterized image data) could be transformed to an output raster (e.g., second version of the rasterized image data) using a transform that uses a pre-determined input-output transform designed to maximize the number of colorants or fluid colors used. The transform can be implemented as a filter that overwrites the input rasters.

In another example, spot colors can be detected in the output of the RIP 122 after compression of the RIP 122 output to Indigo Compressed Format (ICF). The ICF compression process tends to be lossy in both the color and frequency domains. Compressed ICF tiles can be processed as pixels and overwritten in place. Although the compressed ICF domain does not allow all raster operations to be performed, a table-driven color shift to maximize the number of colorants or fluid colors used to produce raster objects is possible in the ICF domain.

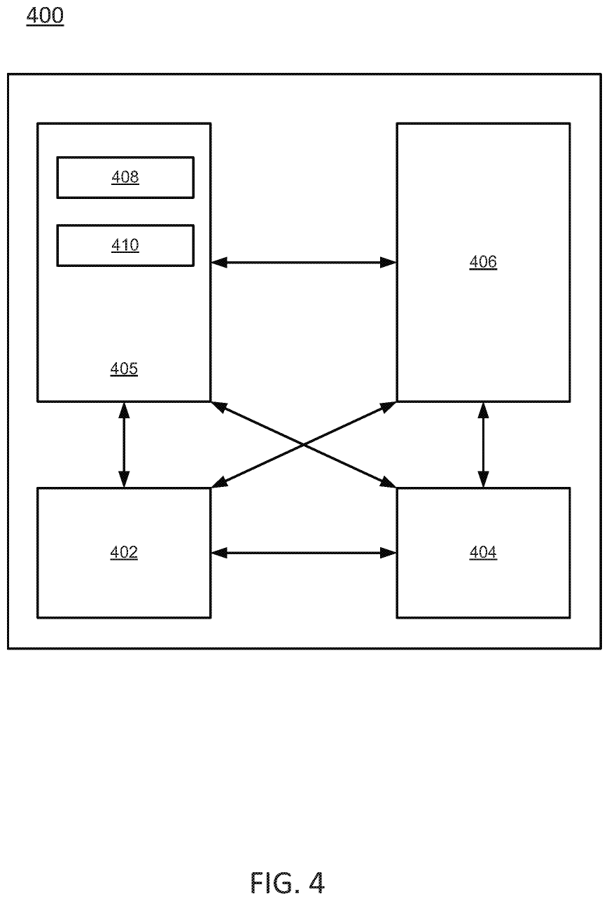

FIG. 4 depicts a high-level block diagram of an example computer that can be transformed into a machine capable of performing the functions described herein. Notably, no computer or machine currently exists that performs the functions as described herein. As a result, the examples of the present disclosure modify the operation and functioning of the general-purpose computer to maximize a number of fluid colors used to produce a spot color, as disclosed herein.

As depicted in FIG. 4, the computer 400 comprises a hardware processor element 402, e.g., a central processing unit (CPU), a microprocessor, or a multi-core processor, a memory 404, e.g., random access memory (RAM) and/or read only memory (ROM), a module 405 for maximizing a number of colorants used to emulate a spot color, and various input/output devices 406, e.g., storage devices, including but not limited to, a tape drive, a floppy drive, a hard disk drive or a compact disk drive, a receiver, a transmitter, a speaker, a display, a speech synthesizer, an output port, an input port and a user input device, such as a keyboard, a keypad, a mouse, a microphone, and the like. Although one processor element is shown, it should be noted that the general-purpose computer may employ a plurality of processor elements. Furthermore, although one general-purpose computer is shown in the figure, if the method(s) as discussed above is implemented in a distributed or parallel manner for a particular illustrative example, i.e., the blocks of the above method(s) or the entire method(s) are implemented across multiple or parallel general-purpose computers, then the general-purpose computer of this figure is intended to represent each of those multiple general-purpose computers. Furthermore, a hardware processor can be utilized in supporting a virtualized or shared computing environment. The virtualized computing environment may support a virtual machine representing computers, servers, or other computing devices. In such virtualized virtual machines, hardware components such as hardware processors and computer-readable storage devices may be virtualized or logically represented.

It should be noted that the present disclosure can be implemented by machine readable instructions and/or in a combination of machine readable instructions and hardware, e.g., using application specific integrated circuits (ASIC), a programmable logic array (FLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the blocks, functions and/or operations of the above disclosed methods.

In one example, instructions and data for the present module or process 405 for maximizing a number of colorants used to emulate a spot color, e.g., machine readable instructions can be loaded into memory 404 and executed by hardware processor element 402 to implement the blocks, functions or operations as discussed above in connection with the methods 200 and 300. For instance, the module 405 may include a plurality of programming code components, including a spot color identifier component 408 and a metameric alternative formulation component 410. These programming code components may be included, for example, in a raster image processor, such as the RIP 122 of FIG. 1.

The spot color identifier component 408 may be configured to identify areas of known spot color in an original image and to look up a metameric alternative colorimetric definition for each spot color. For instance, the spot color identifier component 408 may be configured to perform blocks of the method 200 described above.

The metameric alternative formulation component 410 may be configured to formulate a metameric alternative calorimetric definition of a known spot color, where the metameric alternative colorimetric definition maximizes a number of colorants or fluid colors used to produce the known spot color. The metameric alternative formulation component 410 may store the metameric alternative colorimetric definitions in a database for future use. For instance, the metameric alternative formulation component 410 may be configured to perform blocks of the method 300 described above.

Furthermore, when a hardware processor executes instructions to perform “operations”, this could include the hardware processor performing the operations directly and/or facilitating, directing, or cooperating with another hardware device or component, e.g., a co-processor and the like, to perform the operations.

The processor executing the machine readable instructions relating to the above described method(s) can be perceived as a programmed processor or a specialized processor. As such, the present module 405 for maximizing a number of colorants used to emulate a spot color, including associated data structures, of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, or variations therein may be subsequently made which are also intended to be encompassed by the following claims.

What is claimed is:

1. An apparatus, comprising:
a plurality of fluid ejection devices to eject a plurality of fluids containing a plurality of different colorants;
a database to store an entry for a spot color, wherein the entry defines a first subset of the plurality of fluids that combines to emulate the spot color and a second subset of the plurality of fluids that combines to emulate the spot color, wherein the second subset maximizes a number of the plurality of colorants used; and
a raster image processor to convert a page description of an image including the spot color into rasterized image data using the second subset of the plurality of fluids.

2. The apparatus of claim 1, wherein the second subset also maximizes a number of fluid ejection dies of the fluid ejection devices that is used to emulate the spot color in an output of the apparatus.

3. The apparatus of claim 1, wherein the apparatus is an inkjet printing device.

4. The apparatus of claim 1, wherein the apparatus is a packaging web press.

5. A non-transitory machine-readable storage medium encoded with instructions executable by a processor, the machine-readable storage medium comprising:
instructions to identify, in a page description language definition of an image, an object to be rendered in a spot color, wherein a first colorimetric definition for the spot color identifies a first subset of fluids, selected from a set of available fluids containing a plurality of different colorants, that combines to emulate the spot color;
instructions to retrieve, from a database, a second colorimetric definition for the spot color, wherein the second colorimetric definition for the spot color identifies a second subset of the fluids, selected from the set of available fluids, that combines to emulate the spot color, and wherein the second subset maximizes a number of the different colorants used to emulate the spot color; and
instructions to generate rasterized image data for the page description language definition that specifies the use of the second colorimetric definition to render the object in an output image.

6. The non-transitory machine-readable storage medium of claim 5, wherein the second subset includes a greater number of different colorants than the first subset.

7. The non-transitory machine-readable storage medium of claim 5, wherein the number of different colorants used to emulate the spot color in the second subset is maximized by:
performing a first rasterization of a color swatch for the spot color, wherein the first rasterization produces a default colorimetric definition for the spot color that defines quantities of cyan, magenta, yellow, and black colorants to be mixed to emulate the spot color;
performing a second rasterization of the color swatch for the spot color, wherein the second rasterization produces an alternative colorimetric definition for the spot color that defines quantities of cyan, magenta, yellow, black, and other colorants of the plurality of different colorants to be mixed to emulate the spot color; and
maximizing a number of colorants used in the alternate colorimetric definition to produce the second subset.

8. The non-transitory machine-readable storage medium of claim 7, wherein the maximizing comprises:
decomposing at least colorant included in the alternate calorimetric definition into at least two colorants of the plurality of different colorants.

9. The non-transitory machine-readable storage medium of claim 8, wherein the decomposing comprises:
applying an inverse under color remove function to the at least one colorant.

10. The non-transitory machine-readable storage medium of claim 8, wherein the at least one colorant is a colorant other than cyan, magenta, or yellow.

11. The non-transitory machine-readable storage medium of claim 5, wherein the instructions to generate rasterized image data comprise:
instructions to transform a first version of the rasterized image data into a second version of the rasterized image data using a pre-determined transform designed to maximize the number of different colorants of the plurality of different colorants used to emulate the spot color.

12. The non-transitory machine-readable storage medium of claim 11, wherein the transform is implemented as a filter that overwrites the first version of the rasterized image data.

13. A method, comprising:
identifying, in a page description language definition of an image, an object to be rendered in a spot color, wherein a first colorimetric definition for the spot color identifies a first subset of fluids, selected from a set of available fluids containing a plurality of different colorants, that combines to emulate the spot color;
retrieving, from a database, a second colorimetric definition for the spot color, wherein the second colorimetric definition for the spot color identifies a second subset of fluids, selected from the set of available fluids, that combines to emulate the spot color, and wherein the second subset maximizes a number of the different colorants used to emulate the spot color; and
generating rasterized image data for the page description language definition that specifies the use of the second colorimetric definition to render the object in an output image.

14. The method of claim 13, wherein the number of different colorants used to emulate the spot color in the second subset is maximized by:
performing a first rasterization of a color swatch for the spot color, wherein the first rasterization produces a default colorimetric definition for the spot color that defines quantities of cyan, magenta, yellow, and black colorants to be mixed to emulate the spot color;
performing a second rasterization of the color swatch for the spot color, wherein the second rasterization produces an alternative colorimetric definition for the spot color that defines quantities of cyan, magenta, yellow, black, and other colorants of the plurality of different colorants to be mixed to emulate the spot color; and
maximizing a number of colorants used in the alternate colorimetric definition to produce the second subset.

15. The method of claim 14, wherein the maximizing comprises:
decomposing at least one colorant included in the alternate colorimetric definition into at least two colorants of the plurality of different colorants.
